(19) United States
(12) Patent Application Publication
(10) Pub. No.: US 2012/0302722 A1
(43) Pub. Date: Nov. 29, 2012

(54) COPOLYETHER ESTER ELASTOMER

(75) Inventors: Qun Sun, Wilmington, DE (US); Edwin L. McInnis, Zachary, LA (US)

(73) Assignee: INVISTA North America S.a.r.l, Wilmington, DE (US)

(21) Appl. No.: 13/514,813

(22) PCT Filed: May 6, 2010
(86) PCT No.: PCT/US10/33863

§ 371 Date: Aug. 6, 2012

(30) Foreign Application Priority Data
Dec. 11, 2009 (US) PCT/US2009/067688

(51) Int. Cl. C08G 63/672

(52) U.S. Cl. 528/301

(57) ABSTRACT

The present invention relates to a new thermoplastic copolyether ester elastomer composition comprising a soft segment and a hard segment. The soft segment of the copolyether ester elastomer composition is derived from a random poly(oxyethylene-co-oxytetramethylene ether)glycol and the hard segment is composed of short chain polyester. The present invention also relates to a method for manufacturing the new copolyether ester elastomer composition, and products comprising same.

### CROSS-REFERENCE TO RELATED APPLICATION

This application claims priority from International Application No. PCT/US2010/033863 filed May 6, 2010.

### FIELD OF THE INVENTION

The present invention relates to a new thermoplastic copolyether ester elastomer composition comprising a soft segment and a hard segment. The soft segment of the copolyether ester elastomer composition is composed of long chain polyester which is derived from a random poly(oxyethylene-co-oxytetramethylene ether)glycol, and the hard segment is composed of short chain polyester. The hard segment may be derived from an aromatic dicarboxylic acid and a short chain diol. The composition of the present invention exhibits notably improved properties compared to existing similar compositions generally intended for like uses, such as, for example, fibers, films and other shaped articles. The present invention also relates to a method for manufacturing the new copolyether ester elastomer composition, and products comprising same.

### BACKGROUND OF THE INVENTION

Thermoplastic elastomer (TPE) is a class of polymers which combines the properties of two other classes of polymers, namely thermoplastics, which may be reformed upon heating, and elastomers which are rubber-like polymers. One form of TPE is a block copolymer, usually containing some blocks whose polymer properties resemble those of thermoplastics, and some blocks whose properties resemble those of elastomers. Blocks whose properties resemble thermoplastics are often referred to as “hard” segments, while blocks whose properties resemble elastomers are often referred to as “soft” segments. It is believed that the hard segments provide properties similar to chemical crosslinks in traditional thermosetting elastomers, while the soft segments provide rubber-like properties.

The ratios of hard to soft segments, as well as the type of the segments, determine to a great extent the properties of the resulting TPE. For example, longer soft segments usually lead to TPE having lower initial tensile modulus, while a high percent of hard segments leads to TPE with higher initial tensile modulus. Other properties may be affected as well. Thus, manipulation on the molecular level affects changes in the properties of TPE, and improved TPE materials are constantly being sought.

Frequently the soft segments of TPE materials are formed from poly(alkylene oxide) segments. Current polyether polyols have been based on polymers derived from cyclic ethers such as ethylene oxide, 1,2-propylene oxide and tetrahydrofuran. These cyclic ethers are readily available from commercial sources, and when subjected to ring opening polymerization, provide the polyether glycol, for example, polyethylene glycol (PEG), poly(1,2-propylene) glycol (PPG), PEG capped PPG (EOPPG) and polytetramethylene ether glycol (PTMEG), respectively.

Copolyether ester (COPE) products and their manufacture are disclosed in British Patent 682,866 and U.S. Pat. No. 2,744,087. The two step synthesis of these products is detailed in a review article by W. K. Witsiepe, Adv. Chem. Ser., 129, 39 (1973). The first step is the trans-esterification between dimethylterephthalate (DMT) and a long chain polyol such as PTMEG, PEG, PPG or EOPPG and a short chain diol such as ethylene glycol (EG), 1,4-butanediol (BDO) and so on that is typically catalyzed by a titanium compound such as tetra-n-butyl titanate (TBT). In the second step, the resulting butylene terephthalate and polyether terephthalate from the first step are polycondensated to the final product, the copolyether ester (COPE), by removal of the excess short chain diols under high temperature and high vacuum.

U.S. Pat. No. 3,023,192 discloses segmented copolyether esters and elastic polymer yarns made from them. The segmented copolyether esters are prepared from (a) dicarboxylic acids or ester-forming derivatives,

(b) polyethers of the formula HO(RO)ₙH, and (c) dihydroxy compounds selected from bisphenols and lower aliphatic glycols. In the above formula, R is a divalent radical, and n is an integer of a value to provide a polyether with a molecular weight of 350 to 6,000 dalton. Representative polyethers include polyethylene ether glycol, polypropylene glycol, polytetramethylene ether glycol, polyhexamethylene ether glycol, and so on.

U.S. Pat. No. 4,906,729 (EP 0353768) discloses segmented thermoplastic copolyether ester elastomers having soft segments formed from a long chain polyalkylene ether glycol containing 80 to 97 mol % of copolymerized tetrahydrofuran and 3 to 20 mol % of a copolymerized cyclic alkylene oxide, preferably copolymerized with 3-methyltetrahydrofuran. The copolyether ester elastomers comprise 70 to 90 wt % soft segment and 10 to 30 wt % hard segment. U.S. Pat. No. 5,162,455 (EU 0607256) discloses segmented thermoplastic copolyether ester elastomers comprising at least 70 wt % soft segment and 10 to 30 wt % hard segment.

U.S. Pat. No. 4,937,314 discloses thermoplastic copolyether ester elastomers comprising at least 70 wt % soft segments derived from poly(alkylene oxide)glycols and terephthalic acid. The hard segments constitute at most 30 wt % of the elastomer and are 95 to 100% poly(1,3-propylene terephthalate). The specification discloses that the poly(alkylene oxide)glycols have a molecular weight of from 1,500 to 5,000 dalton and a carbon-to-oxygen ratio of from 2 to 4.3. Representative poly(alkylene oxide)glycols include poly(ethylene oxide) glycol, poly(1,2-propylene oxide)glycol, poly(1,3-propylene oxide)glycol, poly(tetramethylene oxide)glycol, etc. In the examples, the soft segments are based on PTMEG and tetrahydrofuran/ethylene oxide copolyether.

U.S. Pat. No. 5,128,185 describes thermoplastic copolyether ester elastomers comprising at least 83 wt % soft segments derived from poly(alkylene oxide)glycols and terephthalic acid. The hard segments constitute 10 to 17 wt % and comprise poly(1,3-propylenebibenzoate). The specification discloses that the poly(alkylene oxide)glycols have a molecular weight of from 1,500 to 5,000 dalton and a carbon-to-oxygen ratio of from 2.5 to 4.3. Representative examples include poly(ethylene oxide)glycol, poly(1,2-propylene oxide)glycol, poly(1,3-propylene oxide)glycol, poly(tetramethylene oxide)glycol, etc. In the examples, the soft segments are based on PTMEG and tetrahydrofuran/3-methyl tetrahydrofuran.

U.S. Pat. No. 6,670,429 describes a block copolyester comprising a hard segment and a soft segment, wherein the melting point of the copolyester is greater than or equal to 200° C., and the glass transition temperature of the copolyester is less than or equal to −40° C. The hard segment is described as a polyethylene terephthalate, polybutylene terephthalate, or polyethylene naphthalate. The soft segment is described to be formed from at least one dimer fatty acid and/or dimer fatty diol and/or equivalent thereof.

U.S. Patent Publication 2008/0103217A1 describes polyether ester elastomer compositions having polytrimethylene ether ester soft segments and polyethylene ester hard segments and containing a nucleating agent, such as selected from alkali metal salt and alkaline earth metal salt. Shaped articles, particularly molded articles, films and fibers, are disclosed to be made from these compositions.

EP 1,448,657B1 describes polyether ester elastomer comprising from 60 to 90 wt % polytrimethylene ether ester soft segments and from 10 to 40 wt % tetramethylene ester hard segments, and use thereof in fibers and other shaped articles. EP 1,643,019 A1 describes polyether ester elastomer fiber comprising hard and soft segments in the broad ratio of hard/soft in the range of 70/30 to 30/70. The polyoxyethylene glycol as the soft segment in this polyether ester elastomer fiber contains oxyethylene glycol in an amount of not less than 70 mol %, preferably not less than 80 mol % or not less than 90 mol %.

Thermoplastic polyether ester elastomers comprising polytrimethylene ether ester soft segments and tetramethylene ester hard segments are disclosed in U.S. Pat. No. 6,562,457. Thermoplastic polyether ester elastomers comprising polytrimethylene ether ester soft segments and trimethylene ester hard segments are disclosed in U.S. Pat. No. 6,599,625. Thermoplastic polyether ester elastomers comprising a copolymer of a polyether polyol composition component, an aromatic dicarboxylic acid component which comprises at least one aromatic dicarboxylic acid or an ester-forming derivative thereof, and a short-chain diol component which comprises at least one diol are disclosed in U.S. Pat. No. 6,833,428. The thermoplastic polyether ester elastomers disclosed in these publications are said to be useful, for example, in making fibers, films and/or other shaped articles.

Thermoplastic copolyether ester elastomers comprising polytrimethylene ether ester soft segments, in particular polytrimethylene terephthalate, and polyethylene ester hard segments, in particular polyethylene terephthalate, are described in U.S. Patent Publication 2005/0282966A1. These materials are said to have a potential advantage for some uses because the melting point and thermal stability of the polyethylene terephthalate hard segments is higher than those of the hard segments based on tetramethylene or trimethylene esters. Their utility, however, has been limited, particularly in engineering resin applications, because of their relatively low rates of crystallization. The unmodified polyether ester comprising polytrimethylene ether terephthalate soft segments and polyethylene terephthalate hard segments is unsuitable for most injection molding applications. Low crystallization rates cause the polymer to be difficult to pelletize or flake, difficult to spin into fibers, and difficult to process into shaped articles by such methods as thermoforming, injection molding and blow molding, because ejection from the mold of an insufficiently crystallized molding would mean that the article could continue to crystallize when in service.

Typical commercial COPE materials are prepared using PBT hard segment and PTMEG terephthalate soft segment with the PTMEG molecular weight varying from 600 to 2000 g/mol and the PBT hard segment content varying from 25 to 90 wt %. However, when higher molecular weight PTMEG is used, for example 2000 g/mol, in combination with high hard segment concentration, a well known phenomenon of “melt phasing” could occur during transesterification. The melt phasing leads to COPE materials which have two glass transition temperatures (Tg) or a very broad glass transition temperature range. As a consequence, these materials have relatively poor mechanical and dynamic properties such as low tensile strength and low temperature impact resistance and so on, see “Polyester-Based Thermoplastic Elastomers” by R. W. M. van Berkel et al. p. 397 of “Handbook of Thermoplastics” edited by 0. Olabisi, 1997. The possibility of melt phasing limits the molecular weight of the PTMEG and the concentration of the hard segment to be used.

All of the aforementioned publications are incorporated herein by reference.

TPE materials based on those exemplified in the prior art are primarily based on PTMEG, copolymers of tetrahydrofuran and 3-alkyltetrahydrofuran, PEG, PPG and copolymers of these. While a range of copolyether ester TPE materials can be produced based on these polyether polyols, there remains the need for an overall improvement in mechanical, dynamic and thermal properties, including one of more of tensile strength, elongation, stretch-recovery properties, abrasion resistance, and glass transition temperatures. The present invention provides distinct advantages toward achieving an overall improved balance of these properties.

### SUMMARY OF THE INVENTION

The present invention provides a new thermoplastic copolyether ester elastomer composition comprising a soft segment and a hard segment. The soft segment of the copolyether ester elastomer composition of this invention is composed of long chain polyester which is derived from a random poly(oxyethylene-co-oxytetramethylene ether)glycol, and the hard segment is composed of short chain polyester, which may be derived from an aromatic dicarboxylic acid and a short chain diol. The soft segment of the composition of the present invention is represented by the structural formula:

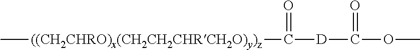

wherein R and R′ are selected from the group consisting of —H, —CH3, —C2H5, and combinations thereof, D is one or more divalent radicals remaining after removal of carboxyl groups from one or more corresponding dicarboxylic acid equivalents, x is an integer equal or greater than 1, y is an integer equal or greater than 1 while the average of x/y is from 0.33 to 3.0, and z is an integer equal or greater than 2 while the average of z is from 4 to 26. The hard segment of the composition of the present invention is represented by the structural formula:

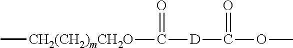

wherein m is an integer equal 0 or 1 or 2, and D is one or more divalent radicals remaining after removal of carboxyl groups from one or more corresponding dicarboxylic acid equivalents.

The soft segment of the composition is less than 70 wt % of the total composition of the copolyether ester. The soft segment is primarily composed of the ester of a copolyether that is derived from the random copolyether glycol of an alkylene oxide and tetrahydrofuran. The tetrahydrofuran may comprise at least one alkyltetrahydrofuran selected from the group consisting of 2-methyl-tetrahydrofuran, 3-methyltetrahydrofuran, 3-ethyltetrahydrofuran, and combinations thereof. The soft segment could also include a second minor component that is blended with the primary random copolyether glycol, and the second component could be polyethylene ether glycol, polypropylene ether glycol, poly(tetramethylene ether glycol) or the block copolyether glycol thereof, with the minor component being less than 50 wt % of the soft segment.

The present composition exhibits notably improved properties compared to existing similar compositions generally intended for like uses, such as, for example, fibers, films, engineering resins and other shaped articles. The present invention also provides a method for manufacturing the new copolyether ester elastomer composition, and products, i.e. articles of manufacture, comprising same.

### DETAILED DESCRIPTION OF THE INVENTION

As a result of intense research in view of the above, we have discovered a new thermoplastic copolyether ester elastomer composition comprising a soft segment and a hard segment, wherein the soft segment is derived from a random poly(oxyethylene-co-oxytetramethylene ether)glycol, and the hard segment is composed of short chain polyester, which may be derived from an aromatic dicarboxylic acid and a short chain diol; a method for manufacturing the thermoplastic copolyether ester elastomer composition; and its advantageous use in articles of manufacture such as fibers, flexible films, engineering resins and other shaped articles.

The term “polymerization”, as used herein, unless otherwise indicated, includes the term “copolymerization” within its meaning.

The term “PTMEG”, as used herein, unless otherwise indicated, means poly(tetramethylene ether glycol). PTMEG is also known as polyoxybutylene glycol. The term “PPG”, as used herein, unless otherwise indicated, means polypropylene ether glycol. The term “EOPPG”, as used herein, unless otherwise indicated, means ethylene oxide capped polypropylene ether glycol. The term “PEG”, as used herein, unless otherwise indicated, means polyethylene ether glycol. The term “DMT”, as used herein, unless otherwise indicated, means dimethylterephthalate, an ester of terephthalic acid and methanol. The term “BDO”, as used herein, unless otherwise indicated, means 1,4-butanediol. The term “TBT”, as used herein, unless otherwise indicated, means tetrabutyltitanate.

The term “alkylene oxide”, as used herein, unless otherwise indicated, means a compound containing two, three or four carbon atoms in its alkylene oxide ring. The alkylene oxide can be unsubstituted or substituted with, for example, linear or branched alkyl of 1 to 6 carbon atoms, or aryl which is unsubstituted or substituted by alkyl and/or alkoxy of 1 or 2 carbon atoms, or halogen atoms such as chlorine or fluorine. Examples of such compounds include ethylene oxide (EO); 1,2-propylene oxide; 1,3-propylene oxide; 1,2-butylene oxide; 1,3-butylene oxide; 2,3-butylene oxide; styrene oxide; 2,2-bis-chloromethyl-1,3-propylene oxide; epichlorohydrin; perfluoroalkyl oxiranes, for example (1H,1H-perfluoropentyl) oxirane; and combinations thereof.

One embodiment of the present invention is a new thermoplastic copolyether ester elastomer composition comprising a soft segment and a hard segment, wherein the soft segment is derived from a random poly(oxyethylene-co-oxytetramethylene ether)glycol and the hard segment is composed of short chain polyester, which may be derived from an aromatic dicarboxylic acid and a short chain diol. The soft segment of the composition of the present invention is represented by the structural formula:

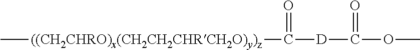

wherein R and R′ are selected from the group consisting of —H, —CH3, —C2H5, and combinations thereof, D is one or more divalent radicals remaining after removal of carboxyl groups from one or more corresponding dicarboxylic acid equivalents, x is an integer equal or greater than 1, y is an integer equal or greater than 1 while the average of x/y is from 0.33 to 3.0, and z is an integer equal or greater than 2 while the average of z is from 4 to 26. The hard segment of the composition of the present invention is represented by the structural formula:

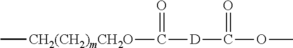

wherein m is an integer equal 0 or 1 or 2, and D is one or more divalent radicals remaining after removal of carboxyl groups from one or more corresponding dicarboxylic acid equivalents. Another embodiment of the invention involves the above wherein one or both R and R′ of the soft segment comprises —H. The copolyether ester elastomer composition comprises from 10 wt % to less than 70 wt %, e.g., 69 wt %, soft segment, and from 30 wt %, e.g., 31 wt %, to 90 wt % hard segment. For example, the copolyether ester elastomer composition comprises from 20 wt % to 65 wt % soft segment and from 35 wt % to 80 wt % hard segment, such as from 30 wt % to 60 wt % soft segment and from 40 wt % to 70 wt % hard segment. As will be demonstrated herein, the present composition exhibits notably improved properties compared to existing similar compositions generally intended for like uses, such as in, for example, fibers, films, engineering resins and other shaped articles.

Another embodiment of the present invention is a method for manufacturing the new thermoplastic copolyether ester elastomer composition. The method comprises sequential steps of (1) combining random poly(oxyethylene-co-oxytetramethylene ether)glycol; aromatic dicarboxylic acid, such as, for example a methyl ester thereof; short chain diol and catalyst in a reaction vessel, (2) maintaining the contents of the reaction vessel at ester interchange (EI) reaction effective conditions including means for removal of by-product methanol, (3) maintaining the contents of the reaction vessel at polycondensation reaction effective conditions, and (4) recovering the copolyether ester elastomer.

Other embodiments of the present invention are articles of manufacture such as fibers, flexible films and shaped articles made from or comprising the new thermoplastic copolyether ester elastomer composition.

A non-limiting example of the copolyether ester elastomer of the present invention has a melting point of from 150° C. to 240° C., for example from 170° C. to 235° C.; a tensile strength of greater than 2500 psi, for example greater than 3000 psi; an elongation at break of greater than 200%, for example greater than 300%; and a single glass transition temperature of the soft segment of less than −50° C., for example less than −55° C. The new copolyether ester elastomer exhibits a lower low temperature stiffening in comparison to copolyether ester elastomers comprising a PTMEG soft segment at comparable hard segment composition, as determined by, for example, the Clash-Berg stiffness test (ASTM D1043).

The poly(oxyethylene-co-oxytetramethylene ether)glycol required for derivation of the soft segment of the new thermoplastic copolyether ester elastomer composition is derived from the random copolymer of ethylene oxide and oxytetramethylene ether glycol, H(OCH₂CH₂)ₐ(OCH₂CH₂CH₂CH₂)_{b})_{c}OH, wherein a is an integer equal or greater than 1, b is an integer equal or greater than 1 while the average of a/b is from 0.33 to 3.0, and c is an integer equal or greater than 2 while the average of c is from 4 to 26. These polyols have a number average molecular weight of from 500 to 5000 dalton and are more polar than PTMEG. The random copolymer poly(oxyethylene-co-oxytetra-methylene ether)glycol, which may comprise from 25 to 75 mol % oxyethylene, for example from 30 to 65 mol % oxyethylene, such as from 40 to 55 mol % oxyethylene, has other benefits, i.e., only primary hydroxyl ends; very low melting point and low viscosity. The random copolymer poly(oxyethylene-co-oxytetramethylene ether) glycol for use herein may have a number average molecular weight of from 500 to 3000 dalton, for example from 1000 to 2500 dalton, such as from 1500 to 2500 dalton.

The poly(oxyethylene-co-oxytetramethylene ether)glycol can be prepared by any method known in the art. The method for making this material is not critical so long as the poly(oxyethylene-co-oxytetramethylene ether)glycol meets the specifications required for use in the present invention. Suitable methods include those described in U.S. Pat. No. 4,139,567 and U.S. Pat. No. 6,989,432, incorporated herein by reference.

The hard segment of the new thermoplastic copolyether ester elastomer composition is composed of short chain polyester, which may be derived from an aromatic dicarboxylic acid and a short chain diol.

The aromatic dicarboxylic acid for derivation of the soft or hard segment comprises at least one or a combination of aromatic dicarboxylic acid or an ester-forming derivative thereof. The D in the above formulae represents one or more divalent radicals remaining after removal of carboxyl groups from one or more corresponding dicarboxylic acid equivalents which are derived from the at least one or a combination of aromatic dicarboxylic acid or an ester-forming derivative thereof. An “ester-forming derivative” of an aromatic dicarboxylic acid means an ester of an aromatic dicarboxylic acid. In general, during the production of the copolyether ester elastomer, a transesterification followed by polycondensation may be conducted by a transesterification reaction and, thereby, any aromatic dicarboxylic acid derivatives which form esters by a transesterification reaction can be incorporated into the copolyether ester elastomer of the present invention as aromatic dicarboxylic acid ester units.

Specific examples of aromatic dicarboxylic acids include terephthalic acid, isophthalic acid, phthalic acid, naphthalene-2,6-dicarboxylic acid, naphthalene-2,7-dicarboxylic acid, diphenyl-4,4′-dicarboxylic acid, 4,4′-diphenoxyethanedicarboxylic acid and 5-sulfoisophthalic acid.

Examples of ester-forming derivatives of an aromatic dicarboxylic acid include dimethyl terephthalate, dimethyl isophthalate, dimethyl phthalate, diethyl terephthalate, dimethyl isophthalate, diethyl phthalate, di-n-propyl terephthalate, di-n-propyl isophthalate, di-n-propyl phthalate, diisopropyl terephthalate, di-n-butyl terephthalate, di-sec-butyl terephthalate, di-t-butyl terephthalate, diheptyl terephthalate, di-2-ethylhexyl terephthalate, diisononyl terephthalate, diisodecyl terephthalate, butylbenzyl terephthalate, dicyclohexyl terephthalate, dimethyl 2,6-naphthalenecarboxylate, diethyl 2,6-naphthalenedicarboxylate, dimethyl 2,7-naphthalenedicarboxylate, diethyl 2,7-naphthalenedicarboxylate, dimethyl diphenyl-4,4′-dicarboxylate, diethyl diphenyl-4,4′-dicarboxylate, dimethyl diphenoxyethanedicarboxylate and diethyl diphenoxyethanedicarboxylate.

The aromatic dicarboxylic acid may further comprise a non-aromatic dicarboxylic acid, such as an alicyclic or aliphatic dicarboxylic acid, and an ester-forming derivative thereof. Specific examples of non-aromatic dicarboxylic acids and ester-forming derivatives thereof include alicyclic dicarboxylic acids, such as 1,4-cyclohexanedicarboxylic acid; aliphatic dicarboxylic acids, such as succinic acid, oxalic acid, adipic acid, sebacic acid, dodecanoic diacid and a dimer acid; and ester-forming derivatives thereof. When the aromatic dicarboxylic acid comprises an alicyclic or aliphatic dicarboxylic acid, the amount of the alicyclic or aliphatic dicarboxylic acid is preferably not more than 15 mol %, based on the molar amount of the aromatic dicarboxylic acid.

A small amount (for example, less than about 2 wt %) of trifunctional carboxyl acid such as, for example, trimethyl trimellitate, could be included in the hard segment to modify the properties of the final copolyether esters.

The short chain diol for derivation of the hard segment comprises at least one diol selected from the group consisting of an aliphatic diol and an alicyclic diol, each having from 2 to 10 carbon atoms. The molecular weight of the short chain diol for use in the present invention is generally not more than 300 Dalton. Examples of the above-mentioned diols include aliphatic diols, such as ethylene glycol, 1,3-propylenediol, 1,4-butanediol, 1,5-pentamethylene glycol, 1,6-hexamethylene glycol, neopentyl glycol and 1,10-decamethylene glycol; and alicyclic diols, such as 1,1-cyclohexanedimethanol, 1,4-cyclohexanedimethanol and tricyclodecanedimethanol. The above-mentioned short-chain diols can be used individually or in combination of two or more compounds. Of the above-mentioned diols useful herein, preferred are ethylene glycol and 1,4-butanediol.

The short chain diol may further comprise an aromatic diol. Non-limiting examples of aromatic diols include xylylene glycol, bis(p-hydroxyphenyl)methane, bis(p-hydroxyphenyl)propane, 2,2-bis[4-(2-hydroxyethoxy)phenyl]propane, bis[4-(2-hydroxyethoxy)phenyl]sulfone and 1,1-bis[4-(2-hydroxyethoxy)phenyl]cyclohexane. When the short chain diol comprises an aromatic diol, the amount of the aromatic diol is generally not more than 15 mol %, based on the molar amount of the short-chain diol.

The method for manufacturing the new thermoplastic copolyether ester elastomer composition comprises the sequential steps of (1) combining random poly(oxyethylene-co-oxytetramethylene ether)glycol; aromatic dicarboxylic acid, such as, for example, a methyl ester thereof; short chain diol and catalyst in a reaction vessel, (2) maintaining the contents of the reaction vessel at ester interchange (EI) reaction effective conditions including means for removal of by-product methanol, (3) maintaining the contents of the reaction vessel at polycondensation reaction effective conditions, and (4) recovering the copolyether ester elastomer. The ester interchange reaction effective conditions of step (2) of the method of the present invention include ambient pressure and a temperature of from 180° C. to 230° C. The polycondensation reaction effective conditions of step (3) of the method of the present invention include a vacuum of from 0.02 to 0.2 torr and a temperature of from 240° C. to 260° C.

Catalysts useful in the ester interchange process step include organic and inorganic compounds of titanium, lanthanum, tin, antimony, zirconium, zinc and combinations thereof. Titanium catalysts, for example, tetraisopropyl titanate and tetrabutyl titanate, are preferred and are added in an amount of from 25 to 1000 ppm, preferably from 50 to 700 ppm, by weight based on the weight of the final polymer. Tetraisopropyl titanate and tetrabutyl titanate are also effective as polycondensation catalysts. Additional catalyst may be added before or after the ester interchange or direct esterification reaction and prior to polymerization. Preferably the catalyst is tetrabutyl titanate (TBT).

Along with the catalyst for use herein, a co-catalyst may optionally be used. Such co-catalysts could comprise metal acetate, such as, for non-limiting example, zinc acetate, manganese acetate or combinations thereof.

Further, a reaction/product enhancing additive may be added to the reaction vessel, such as in step (1). Such additives comprise antioxidants and antifoaming agents. Non-limiting examples of antioxidants for this use include E330 from Albermarle®, IRGANOX® 1010 from Ciba® or combinations thereof. Non-limiting examples of antifoaming agents for this use include Dow Corning 200® Fluids.

In preparing the copolyether ester elastomers of this invention, it may be useful to incorporate known branching agents to increase melt strength. In such instances, a branching agent may be used in a concentration of 0.01 to 0.10 equivalents per 100 grams of polymer. The branching agent can be a polyol having 3 to 6 hydroxyl groups, a polycarboxylic acid having 3 or 4 carboxyl groups, or a hydroxy acid having a total of 3 to 6 hydroxyl and carboxyl groups. Non-limiting examples of polyol branching agents include glycerol, sorbitol, pentaerytritol, 1,1,4,4-tetrakis(hydroxymethyl)cyclohexane, trimethylol propane, and 1,2,6-hexane triol. Suitable polycarboxylic acid branching agents include hemimellitic, trimellitic, trimesic pyromellitic, 1,1,2,2-ethanetetracarboxylic, 1,1,2-ethanetricarboxylic, 1,3,5-pentanetricarboxylic, 1,2,3,4-cyclopentane-tetracarboxylic and like acids. Although the acids can be used as is, it is preferred to use them in the form of their lower alkyl esters.

Steps (2) and (3) of the present method may be conducted under an inert gas atmosphere. Non-limiting examples of suitable inert gases for use herein include nitrogen, carbon dioxide, or the noble gases.

Steps (2) and (3) of the present invention may be carried out continuously to maintain consistency in the product, with one or more other steps of the method being carried out continuously or batch wise, i.e., the feed can be prepared in a large batch and reacted continuously until the batch is consumed. Similarly, the product could be stored and processed after the batch is completely processed in the reactor.

Steps (2) and (3) can be carried out in conventional reactors or reactor assemblies suitable for continuous processes, for example in loop reactors or stirred reactors in the case of a suspension process or in tube reactors.

Feedstock and catalyst can be introduced to the reaction vessel using delivery systems common in current engineering practice either batchwise or continuously. A preferred method of feed delivery combines feedstock components as a liquid mixed feed to the reaction vessel, for example a continually stirred tank reactor (CSTR), in continuous fashion along with the other feed ingredients.

The copolyether ester elastomer of this invention is useful in making fibers, films, engineering resins and other shaped articles. The fibers include monocomponent and multicomponent fiber such as bicomponent fiber (containing the copolyether ester elastomer as at least one component), and can be continuous filaments or staple fiber. The fibers are used to prepare woven, knit and nonwoven fabric. The nonwoven fabrics can be prepared using conventional techniques such as use for melt blown, spun bonded and card and bond fabrics, including heat bonding (hot air and point bonding), air entanglement, etc. Films or membranes could be produced from these copolyether ester elastomers by melt processing. Various engineering resin products such as CVJ boots, hoses, diaphragms, tubing and so on could be shaped using these copolyether ester elastomers taking advantage of their high mechanical strength, good low temperature properties and high service temperatures.

Conventional additives can be incorporated into the copolyether ester elastomer or fiber by known techniques. The additives include, for example, delusterants (e.g., TiO₂, barium sulfide, zinc sulfide or zinc oxide), colorants (e.g., dyes), stabilizers (e.g., antioxidants, ultraviolet light stabilizers, heat stabilizers, etc.), fillers, flame retardants, pigments, antimicrobial agents, antistatic agents, optical brighteners, extenders, processing aids, viscosity boosters, and other functional additives.

The following Examples demonstrate the present invention and its capability for use. The invention is capable of other and different embodiments, and its several details are capable of modifications in various apparent respects, without departing from the spirit and scope of the present invention. Accordingly, the Examples are to be regarded as illustrative in nature and non-limiting.

### Materials

DMT, PTMEG and poly(oxyethylene-co-oxytetramethylene ether) glycol were obtained from INVISTA. BDO, TBT catalyst, magnesium acetate co-catalyst and antioxidant (IRGANOX® 330 E) were purchased from Aldrich Chemical.

### Analytical Methods

In the following experiments, inherent viscosities were determined at a concentration of 0.1 g/dl in m-cresol at 30° C. and reported in dl/g. Melting points of the hard segments were determined by differential scanning calorimeter (DSC) with a heating/cooling rate of 10° C./min. The glass transition temperatures (Tg) were determined by DSC and dynamic mechanical analysis (DMA). The DMA is particularly useful with samples where melt phasing is present during the syntheses, i.e., showing two glass transition temperatures or a very broad Tg. Nuclear magnetic resonance (NMR) spectroscopy was used to determine the composition of the copolyether ester elastomer composition samples. The copolyether ester elastomer samples were dissolved in 1,1,2,2-tetra-chloroethane-D2 for these measurements. For mechanical property testing, the elastomer samples were compression molded and tested as follows: Hardness, Shore (ASTM D2240), Tensile Strength (ASTM D412), Young's Modulus (ASTM D412), Elongation at break (ASTM D412), Tear Strength, Die C (ASTM D1938), Taber Abrasion Loss (ASTM D1044), and Clash-Berg Torsional Stiffness (ASTM D1043).

### EXAMPLES

The experiments were carried out with a 2 liter stainless steel reactor fitted for distillation. A U-shaped stainless steel stirrer was placed about ⅛ inch from the bottom of the reactor. After the reactor was charged with the reagents, catalysts and additives, it was purged with nitrogen to remove air from the system. The reactor was then heated by an electric heater with agitator speed set at 100 rpm. The first reaction, the transesterification or ester interchange, typically started at around 170° C., evidenced by the presence of methanol vapor in the distillation column at which point nitrogen flow was stopped. The ester interchange was continued until the reactor temperature reached about 210° C. and methanol flow ceased to the distillation column. The distillation column was then removed and the reactor was connected to a vacuum system. The reactor temperature was slowly increased to 250° C. and full vacuum was obtained in about 30 minutes. The polycondensation reaction was continued for an additional period of time which was monitored and determined by the torque reading on the agitator under given rpm after full vacuum was obtained. After reaching the predetermined torque reading, the reactor was brought to ambient pressure by refilling with nitrogen, the plug in the bottom of the reactor was removed and the polymer melt was extruded, quenched in a water bath and pelletized by a rotating cutter. The reactor was capable of preparing up to 1 kg copolyether ester elastomer composition per batch.

All parts and percentages are by weight unless otherwise indicated.

### Example 1

The 2 liter reactor was charged with 336 g DMT, 250 g BDO, 325 g random poly(oxyethylene-co-oxytetramethylene ether)glycol that had a molecular weight of 2025 g/mol and oxyethylene incorporation of 49 mol %, 0.692 g TBT catalyst, 0.128 g Mg acetate co-catalyst, and 0.940 g IRGANOX® 330 E antioxidant. The reactor was purged with nitrogen before heating. The agitator speed was set at 100 rpm. At approximately 170° C., methanol started to appear in the overhead distillation column and the nitrogen flow was discontinued. Methanol take-off was started, and methanol was condensed and collected in a receiver. The reactor temperature was then slowly increased to approximately 210° C. The ester interchange finished when no more methanol was seen in the column. The port for the condenser was capped and the reactor temperature was slowly raised to 250° C. while full vacuum, around 0.1 torr, was reached at the same time. The polycondensation started when the BDO was distilled off from the reactor. The polycondensation was conducted for 2.5 hours, at which point the torque reading on the agitator was around 400 N-cm at 20 rpm speed. The vacuum was then broken with nitrogen and the reactor was under slight pressure of about 3 psig. The hot copolyether ester elastomer product was extruded from the bottom of the reactor, quenched in a deionized water bath and pelletized using a cutter. The resulting copolyether ester elastomer composition was composed of 50 wt % PBT hard segment and 50 wt % poly(oxyethylene-co-oxytetramethylene ether) terephthalate soft segment.

### Example 2

Example 1 was repeated except for charging the reactor with 350 g DMT, 264 g BDO, 282 g poly(oxyethylene-co-oxytetramethylene ether)glycol that had a molecular weight of 2025 g/mol and ethylene oxide incorporation of 49 mol %, 0.667 g TBT catalyst, 0.123 g Mg acetate co-catalyst, and 1.000 g IRGANOX® 330 E antioxidant. The resulting copolyether ester elastomer composition was composed of 55 wt % PBT hard segment and 45 wt % poly(oxyethylene-co-oxytetramethylene ether) terephthalate soft segment.

### Example 3

Example 1 was repeated except for charging the reactor with 376 g DMT, 310 g BDO, 250 g poly(oxyethylene-co-oxytetramethylene ether)glycol that had a molecular weight of 2025 g/mol and ethylene oxide incorporation of 49 mol %, 0.499 g TBT catalyst, 0.123 g Mg acetate co-catalyst, and 0.665 g IRGANOX® 330 E antioxidant. The resulting copolyether ester elastomer composition was composed of 60 wt % PBT hard segment and 40 wt % poly(oxyethylene-co-oxytetramethylene ether) terephthalate soft segment.

### Comparative Example 1

Example 1 was repeated except for charging the reactor with 305 g DMT, 227 g BDO, 294 g PTMEG that had a molecular weight of 2000 g/mol, 0.627 g TBT catalyst, 0.116 g Mg acetate co-catalyst, and 0.940 g IRGANOX® 330 E antioxidant. The resulting copolyether ester elastomer composition was composed of 40 wt % PBT hard segment and 60 wt % polytetramethylene ether terephthalate soft segment.

### Comparative Example 2

Example 1 was repeated except for charging the reactor with 383 g DMT, 290 g BDO, 254 g PTMEG that had a molecular weight of 2000 g/mol, 0.508 g TBT catalyst, 0.125 g Mg acetate co-catalyst, and 1.016 g IRGANOX® 330 E antioxidant. The resulting copolyether ester elastomer composition was composed of 50 wt % PBT hard segment and 50 wt % polytetramethylene ether terephthalate soft segment.

### Comparative Example 3

A quantity of commercially available copolyether ester elastomer was purchased from Ashland Inc. having 48 wt % PBT hard segment and 52 wt % EOPPG soft segment. The EOPPG block copolymer had a molecular weight of 2100 g/mol and ethylene oxide incorporation of 36 mol %.

Products of the above experiments were tested for various important properties. The results of these tests are presented in Table 1 below.

TABLE 1

| | Product Sample | | | | | |
|---|---|---|---|---|---|---|
| Property | Ex. 1 | Ex. 2 | Ex. 3 | Comp. Ex. 1 | Comp. Ex. 2 | Comp. Ex. 3 |
| PBT, wt % | 50 | 55 | 60 | 40 | 50 | 48 |
| SS (1) Mw. | 2025 | 2025 | 2025 | 2000 | 2000 | 2100 |
| SS Type | (2) | (2) | (2) | PTMEG | PTMEG | EOPPG (3) |
| Shore D | 47 | 51 | 52 | 47 | 48 | 50 |
| Tensile St. psi | 5735 | 6175 | 6970 | 3500 | 5100 | 2949 |
| Young's Mod. M100 | 1880 | 2222 | 2718 | 1722 | 2200 | 2181 |
| psi | | | | | | |
| % UE | 860 | 912 | 1018 | 529 | 620 | 299 |
| Die C Tear St. ppi | 578 | 604 | 707 | 579 | 751 | 526 |
| Taber Abrasion Loss | 83.8 | 93.9 | 86.9 | 98.2 | 91.0 | 153.8 |
| (mg/1000 rpm) (4) | | | | | | |
| Tg by Tan δ (° C.) | −63 | −60.8 | −61.6 | −57.4 (broad) | −70, 10 | −51.8 |
| Tan δ @ 25° C. | 0.033 | 0.032 | 0.033 | 0.043 | 0.093 | 0.033 |
| Clash-Berg Stiffness (5), | −93.9 | −86.5 | −79.8 | −81.7 | −49.4 | −72.8 |
| T(° C.) = 45,000 psi | | | | | | |

(1) SS is soft segment
(2) poly(oxyethylene-co-oxytetramethylene ether) glycol with 49 mol % oxyethylene ether
(3) block copolymer of EOPPG with 36 mol % oxyethylene ether
(4) H-22 wheel
(5) Clash-Berg torsional stiffness test

It is observed from the results of the above experiments that for essentially the same compositions, the copolyether ester elastomer of the present invention exhibits improved properties of higher tensile strength, higher elongation at break (% UE), similar abrasion resistance and better dynamic properties, i.e. a lower and single soft segment glass transition temperature. DMA data proved a double glass transition temperature for the product of Comparative Example 1, and a very broad glass transition temperature for the product of Comparative Example 2, consistent with melt phasing problems with current such materials during melt polymerization using homopolymer PTMEG and relatively high hard segment content. The products of Examples 1, 2 and 3 each exhibited a single sharply defined glass transition temperature. The Clash-Berg data indicated a lower average low temperature stiffening from the three copolyether esters produced with the random copolyether in comparison to that of the comparative examples.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

When numerical lower limits and numerical upper limits are listed herein, ranges from any lower limit to any upper limit are contemplated.

While the illustrative embodiments of the invention have been described with particularity, it will be understood that various other modifications will be apparent to and may be readily made by those skilled in the art without departing from the spirit and scope of the invention. Accordingly, it is not intended that the scope of the claims hereof be limited to the examples and descriptions set forth herein but rather that the claims be construed as encompassing all the features of patentable novelty which reside in the present invention, including all features which would be treated as equivalents thereof by those skilled in the art to which the invention pertains.

What is claimed is:

1. A copolyether ester elastomer comprising from 10 wt % to less than 70 wt % soft segment and from 30 wt % to 90 wt % hard segment, the soft segment being represented by the structural formula: 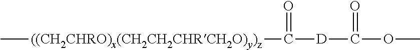
wherein R and R′ are selected from the group consisting of —H, —CH3, —C2H5 and combinations thereof, D is one or more divalent radicals remaining after removal of carboxyl groups from one or more corresponding dicarboxylic acid equivalents, x is an integer equal or greater than 1, y is an integer equal or greater than 1 while the average of x/y is from 0.33 to 3.0, and z is an integer equal or greater than 2 while the average of z is from 4 to 26, and the hard segment being represented by the structural formula: 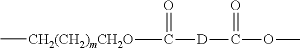
wherein m is an integer equal 0 or 1 or 2, and D is one or more divalent radicals remaining after removal of carboxyl groups from one or more corresponding dicarboxylic acid equivalents, wherein the soft segment is derived from a random poly(oxyethylene-co-oxytetramethylene ether)glycol comprising from 25 to 75 mol % oxyethylene, and the hard segment is composed of short chain polyester derived from an aromatic dicarboxylic acid and a short chain diol.

2. The copolyether ester elastomer of claim 1 wherein one or both R and R′ of the soft segment comprises —H.

3. The copolyether ester elastomer of claim 1 comprising from 20 wt % to 65 wt % soft segment and from 35 wt % to 80 wt % hard segment.

4. The copolyether ester elastomer of claim 1 comprising from 30 wt % to 60 wt % soft segment and from 40 wt % to 70 wt % hard segment.

5. The copolyether ester elastomer of claim 1 having a melting point of from 150° C. to 240° C., a tensile strength of greater than 2500 psi, an elongation at break of greater than 200%, and a single glass transition temperature of the soft segment of less than −50° C.

6. The copolyether ester elastomer of claim 1 wherein the poly(oxyethylene-co-oxytetramethylene ether)glycol comprises from 30 to 65 mol % oxyethylene.

7. The copolyether ester elastomer of claim 1 wherein the poly(oxyethylene-co-oxytetramethylene ether)glycol comprises from 40 to 55 mol % oxyethylene.

8. The copolyether ester elastomer of claim 1 wherein the poly(oxyethylene-co-oxytetramethylene ether)glycol has a number average molecular weight of from 500 to 3000 dalton.

9. The copolyether ester elastomer of claim 6 wherein the poly(oxyethylene-co-oxytetramethylene ether)glycol has a number average molecular weight of from 1000 to 2500 dalton.

10. The copolyether ester elastomer of claim 7 wherein the poly(oxyethylene-co-oxytetramethylene ether)glycol has a number average molecular weight of from 1500 to 2500 dalton.

11. The copolyether ester elastomer of claim 1 wherein the dicarboxylic acid equivalents are derived from one or a combination of aromatic dicarboxylic acids or ester-forming derivatives thereof.

12. The copolyether ester elastomer of claim 9 wherein the aromatic dicarboxylic acids are selected from the group consisting of terephthalic acid, isophthalic acid, phthalic acid, naphthalene-2,6-dicarboxylic acid, naphthalene-2,7-dicarboxylic acid, diphenyl-4,4′-dicarboxylic acid, 4,4′-diphenoxyethanedicarboxylic acid, 5-sulfoisophthalic acid, and combinations thereof.

13. The copolyether ester elastomer of claim 9 wherein the ester-forming derivatives of the aromatic dicarboxylic acids are selected from the group consisting of dimethyl terephthalate, dimethyl isophthalate, dimethyl phthalate, diethyl terephthalate, dimethyl isophthalate, diethyl phthalate, di-n-propyl terephthalate, di-n-propyl isophthalate, di-n-propyl phthalate, diisopropyl terephthalate, di-n-butyl terephthalate, di-sec-butyl terephthalate, di-t-butyl terephthalate, diheptyl terephthalate, di-2-ethylhexyl terephthalate, diisononyl terephthalate, diisodecyl terephthalate, butylbenzyl terephthalate, dicyclohexyl terephthalate, dimethyl 2,6-naphthalenecarboxylate, diethyl 2,6-naphthalene-dicarboxylate, dimethyl 2,7-naphthalenedicarboxylate, diethyl 2,7-naphthalene-dicarboxylate, dimethyl diphenyl-4,4′-dicarboxylate, diethyl diphenyl-4,4′-dicarboxylate, dimethyl diphenoxyethanedicarboxylate, diethyl diphenoxyethanedicarboxylate, and combinations thereof.

14. The copolyether ester elastomer of claim 1 wherein the short chain diol comprises at least one diol selected from the group consisting of an aliphatic diol and an alicyclic diol, each having from 2 to 10 carbon atoms and a molecular weight of the not more than 300 Dalton.

15. The copolyether ester elastomer of claim 12 wherein the short chain diol is selected from the group consisting of ethylene glycol, 1,3-propylenediol, 1,4-butanediol, pentamethylene glycol, hexamethylene glycol, neopentyl glycol, decamethylene glycol, 1,1-cyclohexanedimethanol, 1,4-cyclohexanedimethanol, tricyclodecanedimethanol, and combinations thereof.
